(19) United States
(12) Patent Application Publication
(10) Pub. No.: US 2002/0152109 A1
(43) Pub. Date: Oct. 17, 2002

(54) Method for automatically analyzing and improving an agribusiness operation

(76) Inventor: Thomas Hogan, Marietta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/832,479

(22) Filed: Apr. 11, 2001

(51) Int. Cl. G06F 17/60

(52) U.S. Cl. 705/10

(57) ABSTRACT

Each component agribusiness operation within an agribusiness operation is characterized by an array of baseline agribusiness information documented in a strategic agribusiness plan. A set of numeric indicators of the performance of the component agribusiness operation are identified from the baseline agribusiness information. Target numeric indicators relating to a hypothetical successful component agribusiness operation are maintained within a logic center. Deviations between the numeric indicators relating to the component agribusiness operation and the corresponding target numeric indicators are identified. Possible causes of poor performance relating to the deviations are derived from embedded logic within the logic center. A range of corrective options relating to the group of possible causes are automatically identified.

### TECHNICAL FIELD

The present invention relates to automated methods for managing an agribusiness operation. More particularly, the present invention relates to the use of computers, database resources having embedded logic and capable of communication therebetween via the Internet to develop and convey agribusiness management information and operational efficiency ideas and methods to an agribusiness operator.

### BACKGROUND INFORMATION

An old addage states that a man who has no idea where he is going usually gets there. This wisdom is a succinct analogy to the basic cause of the financial foundering that has overtaken the agribusiness industry.

In the agribusiness industry, and in particular the food animal (beef and pork) industry, mismanagement is notorious. Considering the beef industry, for instance, the average herd size is 38 animals, the average acreage for such an operation is roughly 114 acres. On that land, a rancher typically has more than just his food animals to attend to. For example, he may have a haying enterprise or a land enterprise in addition to a mature cow-calf enterprise and/or a replacement heifer enterprise. In any event, it is quite likely that the rancher has a multi-faceted business operation to manage.

A typical ranching operation is, unmistakably, a business. For nearly every other type of business—including retail, wholesale and manufacturing—very specific financial and operational guidelines have either been set or are readily available for “benchmarking”—a practice whereby one business owner can compare certain key aspects of his business to the businesses of others. In nearly every other type of business, banks require detailed profit and loss statements, a detailed business plan, sustainable financial projections, and the like. In nearly every other type of business, the failure of the business to demonstrate that (a) they have a detailed business plan that will achieve financial success, (b) they are now achieving financial success, and (c) the prospect of future financial success is high, banks and other financial institutions will not continue supporting the business. This reality, in turn, motivates the typical business owner to comply with the directives of the bank in order to both retain the support of the bank and maximize the chance of financial success of the business, based on the use of historically successful management practices.

For some reason, the lessons learned in business management have been lost on the agribusiness industry. Typically, ranchers do not operate under a business plan of any type. They breed their animals. They raise their animals. They sell their animals. They try to make enough money to keep the cycle going over and over again, with little or no regard for profit margin, inflationary effects, business expansion to compensate for family expansion or estate planning. That ranchers—who most often have not had the benefit of any significant business training—operate in this “survival” mode is not surprising. What is surprising is that the financial institutions that support them allow the cycle to repeat year after year, without demanding the same kind of business planning that they would require of a convenience store owner, or a grocer, for instance. The failure of financial institutions to require detailed business planning and management ultimately hurts both the rancher who stumbles by, year after year, in a survival mode, as well as the financial institutions which must deal with defaulted loans and poor rates of return on other agribusiness-related investments and taking over small family farms by large corporations whose financial needs do not include the small town bank.

Large businesses long ago realized the need for comprehensive, forward-thinking business management. The standard management structure to insure such thoughtful management requires a Chief Executive Officer (CEO), Chief Operating Officer (COO), Chief Financial Officer (CFO), and an Executive Assistant (EA). In such a business structure, the CEO provides the vision of the industry, develops the “mission statement” for the business and formulates long-range goals. The COO recommends management changes and improvements, most often by comparing aggregate data on the performance of the business to external or internal benchmarks. The CFO works with the COO to show how certain management changes can affect the cash flow and value of the business, and the EA is normally responsible for operation management scheduling, product pricing and product/supply procurement. Clearly, agribusiness operations, though they could certainly benefit from such a structure, cannot support it financially.

It is impractical to expect financial institutions dealing with ranchers to suddenly begin requiring such detailed business planning. It is improbable to expect ranchers—who have been running their operations in this “seat-of-the-pants” way for many decades—to have any interest in voluntarily entering the difficult and uncharted waters of detailed financial planning and analysis. Accordingly, there is a need for a system that will be easy to use, easy to implement, and which will provide results far greater than the effort expended in its implementation and use.

More specifically, there is a need for an automated agribusiness management system implementing a method by which a rancher can input historical information about his agribusiness operation into an automated system by which a detailed agribusiness analysis can be accomplished and a strategic agribusiness plan can be developed.

There is an additional need for an automated agribusiness management system by which the information input into an automated system can be automatically analyzed in order to make certain determinations about the agribusiness operation, identify current problems within the agribusiness operation, identify possible corrective measures to remedy the problems within the agribusiness operation, then recommend a best course of corrective action for the agribusiness operation.

Finally, there is a need for an automated agribusiness management system which will determine—from automatic analysis of a strategic agribusiness plan—which supplies are critical supply items and which system will, at an appropriate time, determine advantageous sources for the critical supply items and automatically order the critical supply items.

### BRIEF SUMMARY OF THE INVENTION

The present invention provides a method for automatically providing agribusiness operation options and advice to an agribusiness operator. An agribusiness operation will typically have at least one component agribusiness operation and be managed by an agribusiness operator. Each component agribusiness operation has an array of baseline agribusiness information incorporated into a strategic agribusiness plan. Within the information relating to the component agribusiness operation, a set of numeric indicators relating to the component agribusiness operation are identified. These numeric indicators are the basic elements by which the success or failure of the component agribusiness operation are determined.

A set of corresponding target numeric indicators are maintained within a logic center and, upon identification of a particular component agribusiness operation, are compared to the numeric indicators derived from the baseline agribusiness information. Deviations between the numeric indicators relating to the component agribusiness operation and the corresponding target numeric indicators are identified as deviations. A group of possible causes relating to the deviations are derived from embedded logic within the logic center. The embedded logic then also identifies a range of corrective options relating to the group of possible causes. The range of corrective options is presented to the agribusiness operator, with the recommended corrective option also identified to the agribusiness operator.

### BRIEF DESCRIPTION OF THE DRAWINGS

FIG. 1a is the beginning of a flow diagram depicting the steps of an exemplary embodiment of an aspect of the present invention.

FIG. 1b is the continuation of FIG. 1a, depicting the steps of an exemplary embodiment of the present invention.

FIG. 2 is a flow diagram depicting the steps of an exemplary embodiment of an aspect of the present invention.

FIG. 3 is a flow diagram depicting the steps of an exemplary embodiment of an aspect of the present invention.

### DETAILED DESCRIPTION OF EXEMPLARY EMBODIMENTS

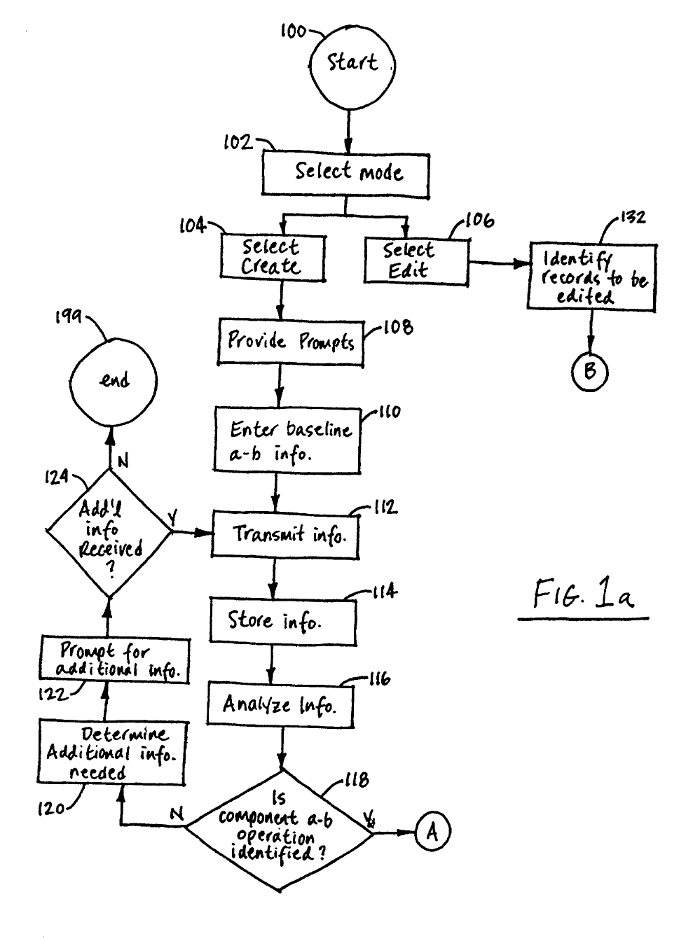

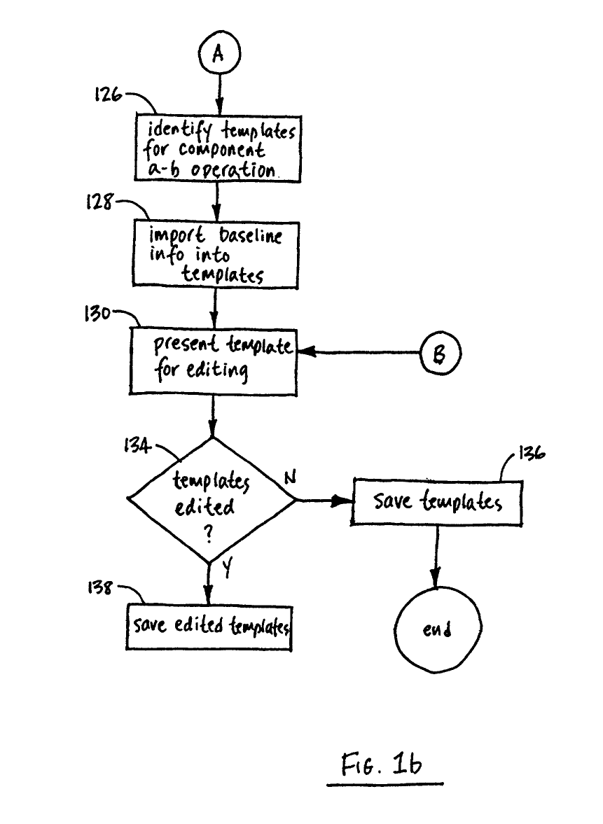

Referring to FIG. 1a, a flow diagram depicting the steps of an exemplary embodiment of an aspect of the present invention is shown. The method of FIG. 1a begins at step 100 and at step 102, the operator—presumably the agribusiness operator, who is also most likely the rancher—selects a mode of operation. In this embodiment, two modes are discussed, “Create” 104 and “Edit” 106. In the Create mode, the agribusiness operator or rancher (for the purposes of this description, the two are used interchangeably) desires to develop a strategic agribusiness plan from scratch. In the Edit mode, the agribusiness operator may call up a current or previously developed agribusiness plan and modify it. In addition to these modes of operation, it is easily conceivable that other modes may exist and have applicability in other embodiments of the present invention. Such additional modes may include boilerplating (using certain variable data as a constant in certain situations), or modeling (in which broadened assumptions can be applied in order to further enhance the ability of the present invention to determine likely outcomes upon the analysis of hypothetical inputs.

The Create mode is selected at 104 and at step 108, prompts are provided to the agribusiness operator to facilitate input of an array of baseline agribusiness information. In a preferred embodiment, the prompts are issued from the logic center and received by the agribusiness operator (hereafter “a-b operator”) on a computer, the prompts being transmitted to the computer via the internet or other suitable communications medium, such as modem or wireless network. At step 110, the a-b operator inputs the array of agribusiness information into the system, responsive to prompts, specific questions, open fields or the like on the computer screen and/or through other computer/user interface devices. The agribusiness information is transmitted to the logic center at step 112 by any one of the wide variety of well known information transmission techniques.

The logic center is the remotely located “artificial intelligence” and information storage facility that makes the functionality of the present invention possible. The exact architecture of the logic center is not critical, and many different architectural arrangements well known to those skilled in the art will suffice. In terms of functionality, the logic center must store and be able to independently access information relating to individual agribusiness operations, generic templates, and a wide variety of collections, analyses and data pertaining to other agribusiness operations and other matters relevant to an agribusiness operation. Embedded within the logic center will be, for instance, a data analysis module which is functional to query the baseline agribusiness information provided by an a-b operator and, depending on the values provided in the baseline agribusiness info, draw conclusions as to which enterprises or component agribusiness operations exist within a single, consolidated agribusiness operation. Such analysis is critical to determining the best and most efficient use of the a-b operator's limited time, independent enterprises and resources.

The term “embedded logic” is a term well known to software developers and those who develop artificial intelligence systems. The manner of use of this term herein is not inconsistent with the commonly understood meaning of the term, and includes an assortment of algorithms functional to take data, apply algorithms to the data, derive numeric outcomes, compare numeric outcomes and their corresponding outcome “actions”, and then automatically or semi-automatically taking an action or directing a consequence in accordance with the outcome action.

The logic center is also functional to communicate with entities other than an a-b operator. For instance, the logic center can communicate with other “B2B” or business-to-business internet sites. This ability is important, and its utilization will be later discussed. In short, the logic center contains embedded logic that allows it to formulate, then analyze the strategic agribusiness plan of an agribusiness operation, then conduct bidding, purchasing and/or ordering exercises on behalf of the agribusiness operation when a need for purchasing or ordering has been identified by either the a-b operator, or by analysis of information contained in the strategic agribusiness plan.

It is also expected that the logic center will be functional to access a wide variety of other informational resources, preferably via the internet, and incorporate that information into information provided back to the a-b operator. Such information that may be accessed by the logic center includes weather trends, norms and precipitation records from a source such as the U.S. Weather -Service, or information on federal, state or local taxes (or incentives) on certain agribusiness operations—which information might affect the positions taken in a strategic agribusiness plan. Additionally, information on current agribusiness trends and discoveries can be accessed from a variety of external sources, if not already directly embedded into an appropriate module within the logic center. Furthermore, the logic center may monitor interest rates at banks, and factor current interest rates into determinations made within the logic center as to when an a-b operator should build another capacity-increasing structure on his ranch, purchase a new farm vehicle, take out a loan to diversify or expand his operation in some other way, etc. In any event, the logic center contains the embedded logic and communicative capability to conduct real-time analyses and conduct real-time inquiries, transactions, ordering and scheduling delivery of mission critical supplies, etc.

The logic center is also functional to sort and selectively access cumulative information from the vast number of strategic agribusiness plans contained in its database. As an a-b operator inputs baseline agribusiness information, develops a strategic agribusiness plan, then modifies the plan, builds on the plan, and otherwise updates the plan with new data, this “trail” of data input and results is maintained for purposes such as data mining in the logic center database. Such a database may be relational in nature, and is capable of searching, sorting, categorizing, etc. in ways that will be useful to a-b operators, bankers, researchers, insurance and pharmaceutical companies, estate planners, federal agencies, etc.

Returning now to FIG. 1a, the baseline agribusiness information is received by and stored in a logic center database at step 114, then the Logic center analyzes, at step 116, the baseline agribusiness information submitted by the a-b operator to determine whether any individual component business operation exists.

Most a-b operators actually manage several small component businesses operations (interchangeably referred to as “enterprises”) within the larger umbrella of their agribusiness operation. For example, the traditional rancher will normally operate four (4) enterprises: a Land Enterprise, a Cow-Calf Enterprise, a Haying Enterprise and a Replacement Heifer Enterprise. The highest percentage of the a-b operators actually only manage one or at best two of these enterprises profitably. The others are managed or maintained at a financial loss, though the a-b operator is not aware of the loss because it is hidden within the consolidated tax return or bank cash flow. The tax return and cash flow documents are normally the only two documents the a-b operator will even casually glance at on an annual basis. It is traditional for the a-b operator to be self-sufficient—therefore maintaining all of the enterprises he feels necessary to operate the business as a whole.

In an embodiment of the present invention, the logic center poses to the a-b operator a simple, straightforward question such as “Do you have a haying enterprise?” or “Do you have a replacement heifer enterprise?”. If a rancher indicates “yes” to one of these questions, the presence of that enterprise is assumed and the process continues as later described. If, on the other hand, an a-b operator doesn't realize that he has, for instance, a haying operation and answers “no” to the question, he may be asked additional haying-related questions later in the process. For example, if an a-b operator indicated that he did not have a haying operation, yet indicated a relatively large amount of expenses in the areas of maintenance, repair and fuel use, the question regarding the haying operation would be asked again, but in a different format. In such a situation, the logic center may inquire “What is the source of your winter feed for the cow herd?”. If the a-b operator indicates that he provides the hay himself, he would then be identified as having a haying operation, just as if he had answered “yes” to the initial question.

This functionality is represented, generally, by decision block 118, where a determination is made as to whether a component agribusiness operation (“component operation”) has been identified. It is important that each component operation be identified, because it is only by identifying and separating the otherwise intermixed data relating to each component operation that each component operation can be compared to target and other data in the Logic center and, ultimately, recommendations for improving each individual component operation—and the a-b operation as a whole—can be derived.

If, at decision block 118, no component operation has been identified, embedded logic in the Logic center may determine, at step 120, what additional information is needed from the agribusiness operator in order to establish that one or more component operations exist. For instance, if there are a group of, for instance, 20 indicators that would indicate a haying operation, and if only 18 of those indicators are present, an embodiment of the present invention may specifically query the agribusiness operator as to the possible presence of the other two indicators on the theory that their inclusion in the baseline of agribusiness information may have been somehow overlooked. This determination may then lead to a prompt to the agribusiness operator in step 122 requesting input of certain additional information. If the additional information is not received at decision block 124, the method ends at step 199 because not enough information has been received to perform a meaningful analysis of a component agribusiness operation. If, on the other hand, the additional information is received at decision block 124, the method resumes at step 112 with the transmission of the information to the logic center, then the additional information supplementing in the logic center database the information already submitted, at step 114. Then, presumably, the analysis of step 116 and inquiry of decision block 118 will reveal that at least one component operation has been identified.

FIG. 1a is continued in FIG. 1b, and at step 126, at least one template is identified from within the logic center for each component operation that has been identified. It is most likely that an array of templates will be needed to capture the relevant information submitted on even a single component operation of an a-b operation. The templates, generally, are pre-designed forms that provide a uniform, standardized means for capturing similar information from a variety of different a-b operations. In a preferred embodiment, the templates may organize data by production unit. For instance, a Cow-Calf Enterprise may set up a profit and loss statement (P&L) so that information is sorted by Per Exposed Female, Per Animal Weaned, Per Pound Weaned. The P&L may also be organized by Item that can most easily be effected by management of the enterprise, starting with Revenues, then moving to Expenses, organized by category. This production unit organizational scheme is more readily understood and appreciated by a typical a-b operator than simple accumulated dollar figures would be. Once similar information from different a-b operations is captured in identical template formats, the accumulation and analysis of the captured information is greatly simplified. The actual importing of the baseline agribusiness information into the respectively selected templates is accomplished in a well-known manner in step 128 and the completed template is provided to the agribusiness operator for editing at step 130.

Templates, generally, cover a wide variety of subject matter. Though individual templates are often designed to be populated by information relating to a particular aspect of a business or system, this is not an inflexible principle. In the context of an embodiment of the present invention, templates may be dedicated to cash flow, management assumptions, calendar of events, etc. Optimally, dozens—if not hundreds—of templates will exist and be accessible to the logic center. If a particular component agribusiness operation is identified, templates relating to that operation will be identified and populated with data, as elsewhere described.

Similarly, if, at step 106, an agribusiness operator selected the Edit mode and thereafter, at step 132, identified the records to be edited, the identified records would be retrieved from a database associated with the logic center, and the a-b operator would arrive at step 130 (FIG. 1b) ready to edit an existing template.

Editing privileges may be established for the editing step, depicted in decision block 134, allowing only certain authorized individuals the ability to edit the templates for an agribusiness operation. Although the system in its present configuration does not verify the accuracy of information input by agribusiness operators, accurate information is desirable, and so minimizing the number of outside sources of editing is similarly desirable.

If, at decision block 134 no edits are made, the templates are saved in their current form in the Logic center database at step 136 and the method ends at step 199. If edits are made, both the edits and the edited templates are saved in the Logic center database (step 138) and the method ends at step 199.

An aspect of an embodiment of the present invention facilitates development of a mission statement for an a-b operation, as well as long range goals for the a-b operation. More specifically, a mission statement is a statement which a business uses to articulate its overarching goals relating to its line of business. It is generally believed that a mission statement is as important for those inside a business as it is for those outside the business. Those outside the business can glean from the mission statement an obvious manifestation of business intent, while those inside the business often find the mission statement useful in helping them to stay focused on their primary objectives—a task that can be difficult in a complex business environment with many variables.

Agribusiness is such a complex business, complicated further by the reality, discussed earlier, that most a-b operators are not savvy business people. Most a-b operators would do well to stay focused. Over time, mission statements have been developed by successful a-b operators that apply equally to other a-b operators. Because of the different possible combinations of component a-b operations within a single agribusiness operation, mission statements can differ significantly depending on the composition of a particular agribusiness operation.

In an embodiment of the present invention, the logic center has access to a significant number of mission statement modules. Each mission statement module is a part of an overall mission statement which articulates, for a single component agribusiness operation, a single overall “mission” for the component agribusiness operation. In fact, for each single component agribusiness operation, there may be stored any number of possible mission statement modules, with the analysis of which mission statement module is appropriate for a particular component agribusiness operation within a particular agribusiness operation being determined by secondary factors such as those considered by embedded logic within the logic center.

When at least one mission statement module is selected for each component agribusiness operation, the mission statement modules are formed into a single, comprehensive mission statement for the agribusiness operation. It will be understood and appreciated that this manner of constructing a mission statement may not produce a grammatically correct or visually pleasing statement, so an embodiment of the present invention will provide the a-b operator with the ability to choose from several example mission statements and to edit the final, chosen mission statement.

An embodiment of the present invention accomplishes the same basic outcome by the same basic process in the development of long-range goals for an agribusiness operation. More particularly, embedded logic within the logic center evaluates the agribusiness operation by first evaluation individual component agribusiness operations. The embedded logic has access to a wide variety of widely recognized generic long-range goals and can assemble, upon completion of an evaluation of component agribusiness operations, a set of long-range goals which articulate a vision of growth, increased profitability, etc.

When long-range goals are established, it triggers the logic center to assign Action Plans, which include Expected Completion Dates (“ECDs”). Action Plans are the “recipe” that lead the a-b operator—in a step-by-step fashion—through the successful implementation and completion of the Long Range Goals.

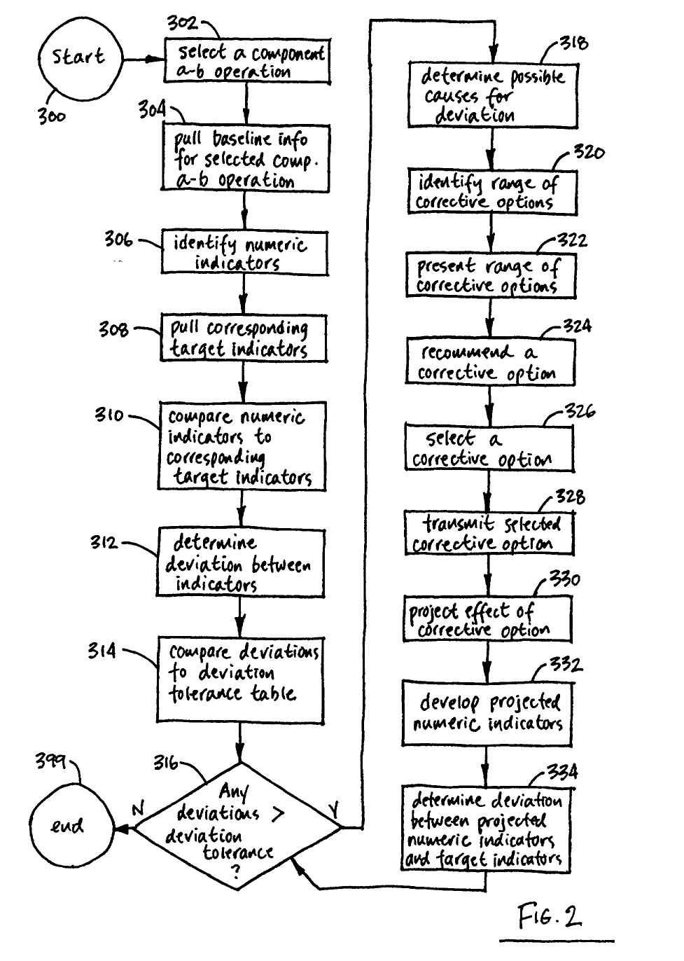

FIG. 2 is a flow diagram depicting representative steps of an exemplary embodiment of an aspect of the present invention.

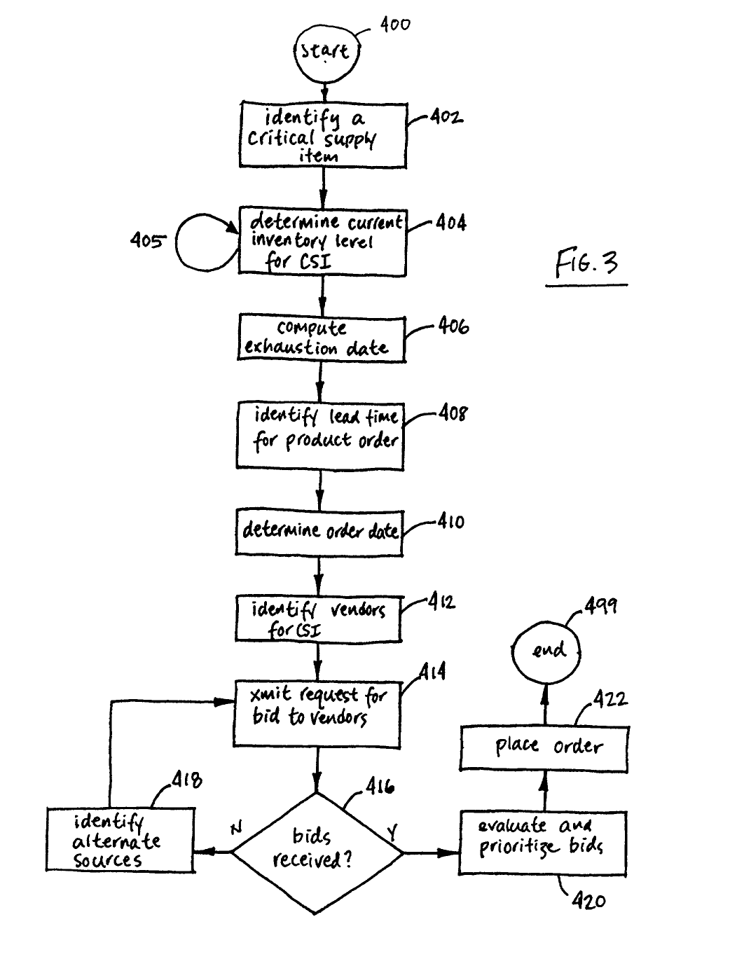

The method of FIG. 2 starts at 300 and, at step 302 a component agribusiness operation is identified for analysis. As previously described with regard to FIGS. 1a, 1b and 2, an array of baseline agribusiness information is gathered and evaluated by the logic center to determine what component agribusiness operations exist within a particular a-b operation. FIG. 3 depicts the process of analysis of each component agribusiness operation which was identified by the process depicted in FIGS. 1 a, 1b and 2.

After a component a-b operation is selected in step 302, the particular baseline agribusiness information relating to that particular component agribusiness operation is identified and “pulled” for analysis at step 304. By “pulled” it will be understood and appreciated that the information may not actually be removed or spared from the other information relating to the other aspects of the a-b operation, but that it may simply be tagged or otherwise identified for ready comparison. At step 306, selected numeric indicators are identified from within the set of pulled baseline agribusiness information relating to the component agribusiness operation.

Thereafter, at step 308, a set of corresponding target indicators relating to component agribusiness operations of the type selected in step 302 are identified within the logic center. These target indicators are embedded within the logic center and may be modified with time, as industry practices change, as more data becomes available, or depending on which region of the country the analysis pertains to or what time of the year is—perhaps even what local or regional weather conditions have been like. In any event, this set of target indicators reflect values that should be present in a properly functioning a-b operation, with acceptable tolerances indicated.

At step 312, a simple mathematical algorithm determines the deviation, if any, between the target indicators and their corresponding set of numeric indicators. The acceptable tolerances are applied at step 314 and, at decision block 316, a determination is made as to whether the deviations fall within the acceptable range of tolerances. If the deviations do not exceed the acceptable tolerances, the method ends at step 399. If, on the other hand, the deviations exceed tolerances, embedded logic from within the logic center determines, based on the values in question and possible values not in question, a list of possible causes.

Each possible cause identified within the Logic center has associated with it a corresponding range of corrective options. This range of correlating possible causes is identified at step 320 and presented to the agribusiness operator at step 322.

At step 324, further analysis of the deviations and the range of possible causes and corrective options by embedded logic in the logic center reveals a recommended corrective action to the agribusiness operator from the range of corrective options. A recommended corrective option can be identified from within a range of possible corrective options in any number of ways. More specifically, possible corrective options can be weighted in terms of desirability based on the amount of deviation between numeric indicators and target indicators. Certain levels of deviation, for instance, may require more drastic measures, which measures may be conveyed to the agribusiness operator in the form of a particular recommended corrective option. A more sophisticated method for determining a recommended corrective option involves evaluating not only a particular deviation between a numeric and a target indicator, but considering (numerically) other values of other numeric indicators. Whether the embedded logic employs one or the other of these methodologies, or an altogether different methodology for recommending a corrective option, a recommended corrective option or options have been identified to the agribusiness operator.

Thereafter, at step 330, the effect of the recommended corrective option(s) is projected against the baseline (or most current) agribusiness information relating to the agribusiness operation in question. This projection is most likely based on historical analyses of other agribusiness operations, along with certain analog factors maintained within the logic center. At step 332, the results of the re-calculated projections for the component agribusiness operation—employing the recommended corrective option—are used in a well-known manner to develop a set of projected numeric indicators.

At step 334, the projected numeric indicators are compared to the target indicators to develop a projected deviation therebetween. If the projected deviation is greater than the deviation tolerance (decision block 316), the process of determining possible causes, beginning again at step 318, begins again. Eventually, this cycle, running at the speed of today's information and logic processing technology, can run through this analysis “loop” rapidly develop a set of recommended options for an agribusiness operator that will allow him to bring, if possible, each of his individual component agribusiness operations within a range of industry acceptable specifications, thereby tremendously increasing the profitability of each of his operations. By the expression “run through the loop”, it will be well understood to those skilled in the art that each time a deviation is identified and a solution selected, other of the numeric indicators may change. It is conceivable that a numeric indicator that was within an acceptable range during an initial evaluation may fall out of acceptable tolerances after a corrective action has been selected to resolve a different deficiency. In this situation, the logic center directs this process to run over and over again (at extremely high speeds) so that situations such as this can be resolved quickly and judiciously.

In an embodiment of the present invention the logic center analyzes the final changes and solutions suggested by the logic center and accepted by the a-b operator. If changes are recommended and accepted by the logic center, a boiler-plate paragraph of explanation as to the importance or relevance of the change may be included in the P&L statement.

FIG. 3 is a flow diagram depicting the steps of an exemplary embodiment of another aspect of the present invention. The method of FIG. 3 begins at step 400 and, at step 402, a critical supply item is identified by the logic center evaluating the strategic agribusiness plan. In general, many items will be considered critical supply items. For instance, certain medical regimens that must be given to all animals is a critical supply item because it is known that the animals must receive the medicine. There are many medicine items of this type, each of which may be considered critical supply items. Other items that may be considered critical supply items can be determined by evaluation of the strategic agribusiness plan. The logic center contains embedded logic that is capable of identifying—for different component agribusiness operations, what part of the country the operations are located, and other relevant factors—what supplies are critical and which are not.

After critical supply items have been identified at step 402, the current inventory for these items is determined in step 404. Initially, an inventory of the amount of the item on hand may have to be manually performed and the amount entered. Thereafter, the inventory level can be automatically monitored by communicative interconnection with the automated ordering system and possibly a system which records the amount of a critical supply item which is used as it is actually being used (or in close proximal relation thereto). The constant (or periodic) checking of the inventory level is denoted by loop 405.

At step 406, an exhaustion date is calculated for the critical supply item. In one embodiment, this date is calculated (in the case of an animal medicine) by determining an on-hand amount of the critical supply item, the amount and frequency of usage, and the number of animals the usage will have to be performed on. Another critical supply item may be something less frequently ordered like, for instance, salt blocks. Salt blocks may last many months or years. The manual monitoring of salt blocks is neither critical nor an efficient use of time. Accordingly, an agribusiness operator may just choose to replace his salt blocks every 18 months. This info is entered into the logic center, and the “exhaustion date” will simply be 18 months from the time of installation of the salt block. The a-b operator has one less thing to worry about.

The lead time for a particular item is identified in step 408. For many items, a “safe range” is identified to allow ample time for product arrival before the exhaustion date. Optionally, factors such as desired quantity and time of year (and other factors) may also be considered, because re-ordering certain products in high-demand times (winter, for instance) may create bigger delays that ordering the same product in the summer. A measure of accuracy is important in this step, as in all of the time-calculation steps, because the agribusiness operator may rather not have a large variety or quantity of items stockpiled in a barn or warehouse. It follows from step 408 that an order date is determined at step 410 and entered on an internal calendar within the logic center, from which the ordering process is driven.

At step 412, a set of vendors or suppliers for the particular critical supply item is identified. These vendors may have been entered by the developers of the logic center, may have been subsequently entered by someone maintaining the logic center, or may be obtained by an action of the logic center such as polling a particular source external to the logic center by a means such as the internet to determine a group of vendors or suppliers. In any event, once the set of vendors is identified, the logic center may direct that a request for bid to supply the critical supply item be sent in step 414.

At decision block 416, an inquiry is made as to whether bids have been received. If not, alternate sources of suppliers are identified at step 418. If bids have been received, the bids are evaluated at step 420 by comparison of the bid—price, delivery time, quantity, and other factors—and the received bids are prioritized. At step 422, an order is placed automatically by the logic center sending out an order in a format and by a means approved by the vendor, and the process ends at step 499.

I claim:

1. A method for automatically providing agribusiness operation options and advice to an agribusiness operator, comprising the steps of:
a. for an agribusiness operation having a component agribusiness operation managed by an agribusiness operator, the component agribusiness operation having an array of baseline agribusiness information in a strategic agribusiness plan, comparing a set of numeric indicators relating to the component agribusiness operation from within the strategic agribusiness plan to a set of corresponding target numeric indicators maintained within a logic center;
b. identifying a deviation between the numeric indicators relating to the component agribusiness operation and the corresponding target numeric indicators maintained within the logic center;
c. embedded logic within the logic center determining a group of possible causes for the deviation;
d. embedded logic within the logic center identifying a range of corrective options correlating to the group of possible causes for the deviation;
e. presenting the range of corrective options to the agribusiness operator; and
f. identifying from the range of corrective options a recommended corrective option to the agribusiness operator:

2. A method for automatically providing agribusiness operation options and advice to an agribusiness operator, comprising the steps of:
a. for an agribusiness operation having a component agribusiness operation managed by an agribusiness operator, the component agribusiness operation having an array of baseline agribusiness information in a strategic agribusiness plan, comparing a set of numeric indicators relating to the component agribusiness operation from within the strategic agribusiness plan to a set of corresponding target numeric indicators maintained within a logic center;
b. identifying a deviation between the numeric indicators relating to the component agribusiness operation and the corresponding target numeric indicators maintained within the logic center;
c. embedded logic within the logic center determining a group of possible causes for the deviation;
d. embedded logic within the logic center identifying a range of corrective options correlating to the group of possible causes for the deviation;
e. presenting the range of corrective options to the agribusiness operator;
f. identifying from the range of corrective options a recommended corrective option to the agribusiness operator;
g. recording a selected corrective option submitted to the logic center by the agribusiness operator; and
h. projecting the effect of the selected corrective option on the strategic agribusiness plan.

3. A method for automatically providing agribusiness operation options and advice to an agribusiness operator, comprising the steps of:
a. for an agribusiness operation having a component agribusiness operation managed by an agribusiness operator, the component agribusiness operation having an array of baseline agribusiness information in a strategic agribusiness plan, comparing a set of numeric indicators relating to the component agribusiness operation from within the strategic agribusiness plan to a set of corresponding target numeric indicators maintained within a logic center;
b. identifying a deviation between the numeric indicators relating to the component agribusiness operation and the corresponding target numeric indicators maintained within the logic center;
c. embedded logic within the logic center determining a group of possible causes for the deviation;
d. embedded logic within the logic center identifying a range of corrective options correlating to the group of possible causes for the deviation;
e. presenting the range of corrective options to the agribusiness operator;
f. identifying from the range of corrective options a recommended corrective option to the agribusiness operator;
g. recording a selected corrective option submitted to the logic center by the agribusiness operator;
h. projecting the effect of the selected corrective option on the strategic agribusiness plan; and
i. presenting the projected effect of the selected corrective option to the agribusiness operator.
